(19) United States
(12) Patent Application Publication
(10) Pub. No.: US 2014/0072728 A1
(43) Pub. Date: Mar. 13, 2014

(54) WIRE AND CABLE EXTRUSION PROCESSES

(71) Applicant: Joseph I. BRISKEY, Aptos, CA (US)

(72) Inventor: Joseph I. BRISKEY, Aptos, CA (US)

(73) Assignee: Apple Inc., Cupertino, CA (US)

(21) Appl. No.: 13/609,217

(22) Filed: Sep. 10, 2012

(51) Int. Cl. B05C 1/04; B06B 1/00

(52) U.S. Cl. 427/600; 118/612

(57) ABSTRACT

An extrusion system includes a die and tip defining an extrusion cavity is described. The extrusion cavity is configured to receive material for extrusion and coating one or more wires. Furthermore, the die is configured to vibrate at an ultrasonic frequency during coating the one or more wires.

### FIELD OF THE DESCRIBED EMBODIMENTS

The described embodiments relate generally to wire and cable extrusion, and more particularly, to the disruption of shear stresses during wire and cable extrusion.

### BACKGROUND

Conventionally, wire and cable for personal electronic devices may be covered with an insulator jacket or jacketing. The insulator jacket may provide a plurality of features, including protection and wear reduction of underlying conductors. Depending upon a particular material and extrusion process used for the insulator jacket, cosmetic surfaces (e.g., surfaces visible by users) of wire and cable may include a variety of physical attributes which are undesirable.

For example, halogen-free flame retardant (HFFR) material, including rubber and silicone compounds, may be used in an extrusion process to coat wire and cable as an insulator jacket. The cooled insulator jacket may display several undesirable physical attributes including weld lines, seams, surface roughness, glossy surfaces, and/or other undesirable attributes. Experimental adjustments to the extrusion process including temperature disparity increases and wire velocity adjustments may allow reduction of some undesirable attributes under certain conditions. However, even controlled and automated changes to the extrusion process may lack repeatability of a desirable set of physical attributes, making it difficult to implement any experimental adjustments to real world manufacturing scenarios.

Therefore, what is needed is an adaptable extrusion process which overcomes these drawbacks and allows controlled repeatability of desirable physical attributes in a plurality of insulator jacket materials.

### SUMMARY OF THE DESCRIBED EMBODIMENTS

This paper describes various embodiments that relate to wire and cable extrusion processes.

According to one embodiment of the present invention, an extrusion system includes a die and tip defining an extrusion cavity. The extrusion cavity is configured to receive material for extrusion and coating one or more wires. Furthermore, the die is configured to vibrate at an ultrasonic frequency during coating the one or more wires.

According to an additional embodiment of the present invention, an extrusion system includes a crosshead configured to receive and distribute material for extrusion and a die and tip defining an extrusion cavity in mechanical communication with the crosshead. The extrusion cavity is configured to receive the material for extrusion and coating one or more wires. Furthermore, the crosshead is configured to vibrate at an ultrasonic frequency and transfer vibrations to the die and tip during coating the one or more wires.

According to an additional embodiment of the present invention, a method for cable extrusion includes feeding wire into an extrusion system for coating with extruded material, vibrating at least a die of the extrusion system at an ultrasonic frequency during coating the wire to created coated wire, and cooling the coated wire

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

Various aspects of this disclosure may be better understood upon reading the following detailed description and upon reference to the drawings in which:

FIG. 1 is a wire extrusion system, according to an embodiment of the invention.

FIG. 2 is a flowchart of a method for cable extrusion, according to an embodiment of the invention.

FIG. 3 illustrates flow characteristics of material flowing through a stationary die and tip of a wire extrusion system.

FIG. 4 illustrates flow characteristics of material flowing through a vibrating die and/or tip of a wire extrusion system.

FIGS. 5A-5B illustrate shear stress and velocity changes due to a vibrating die and/or tip of a wire extrusion system.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

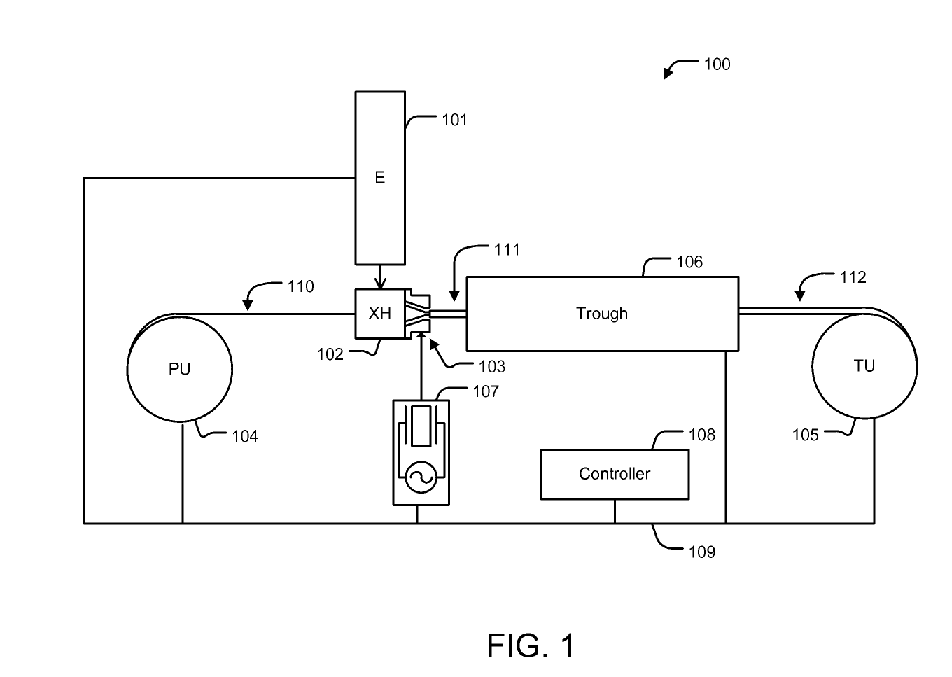

Turning to FIG. 1, a wire extrusion system 100 is illustrated, according to an embodiment of the invention. The system 100 may include material extruder 101. The material extruder 101 may include any suitable material extruder, and may include a plurality of separate components not individually illustrated for clarity. For example, the material extruder 101 may include a heating element to melt or soften jacket material, a hopper or feeder to supply raw or processed jacket material, and/or a material pump or screw to force softened or molten jacket material onto or through crosshead 102.

Crosshead 102 may be a member configured to receive molten or softened jack material from the material extruder 101 and force the same through die and tip set 103. The crosshead 102 may include an inlet to receive material and a manifold to distribute the received material into an extrusion cavity defined/formed by the die and tip set 103. The die and tip set 103 may be in mechanical communication with the crosshead 102 through the defined extrusion cavity.

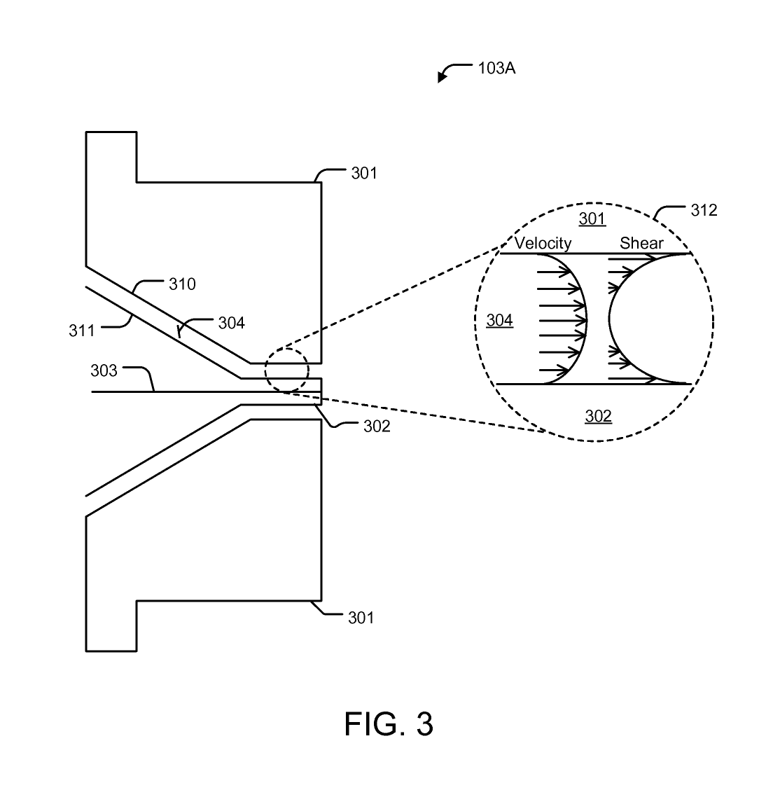

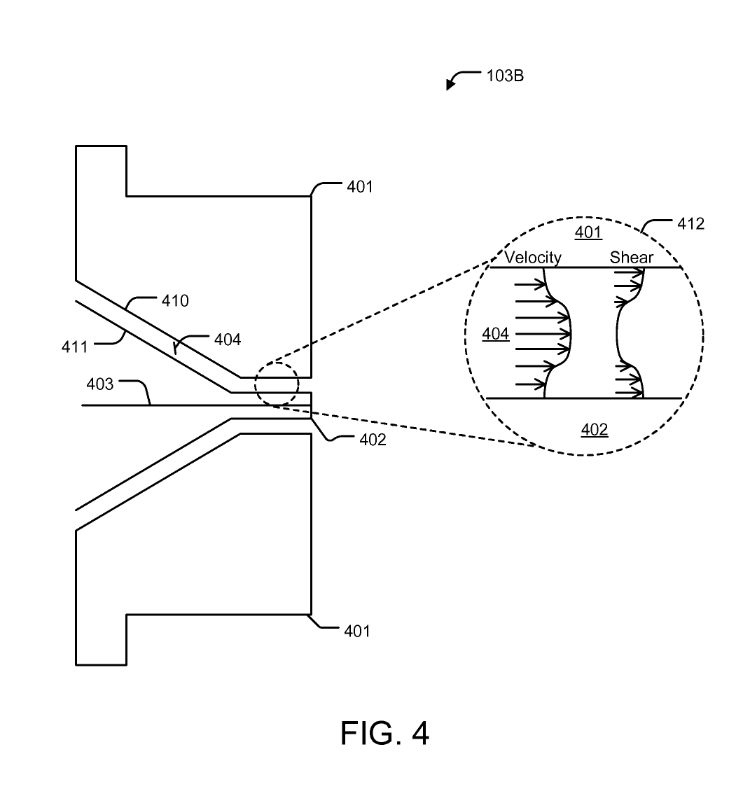

The die and tip set 103 may be components configured to receive and distribute jacket material over a wire, conductor, or plurality of the same, and may take a plurality of forms. For simplicity of discussion and brevity of text, exhaustive descriptions of every possible shape and form of a die and tip set are omitted herein. Example die and tip sets 103A and 103B are illustrated in FIGS. 3-4.

The system 100 may further include a Payoff 104 configured to hold and supply wire 110 to crosshead 102. Payoff 104 may be coupled to a motor or rotating mechanism configured to facilitate unwind and supply wire 110 from one or more reels configured to hold the wire 110. Wire 110 may include a single conductor, several insulated conductors, a set of insulated and non-insulated conductors, cabling, or any other suitable length of material to be coated with jacket material extruded through the system 100. According to one embodiment, the wire 110 is a communication cable for communicating electronic signals to/from a personal electronic device. According to another embodiment, wire 110 is a power cable for supplying power to a personal electronic device. According to another embodiment, wire 110 is a set of audio wires for transferring analog audio signals from a personal electronic device. According to another embodiment, wire 110 is a cable having at least one insulated conductor and shielding. It is noted that the examples listed above are not exhaustive, and discussion of every possible wire to be processed through system 100 is beyond the scope of this disclosure.

The system 100 further includes trough 106 configured to receive and cool coated wire 111 received from die and tap set 103. The trough 106 may be configured to actively or passively cool extruded material coating the coated wire 111. The trough may be integrally or fixedly attached proximate the die and tap set 103, or may be separated by a predetermined distance. According to one embodiment, the trough 106 is substantially formed of a conductive material configured to act as a heat sink. According to another embodiment, the trough 106 includes one or more heat sinks configured to receive heat from extruded material coating the wire 111. According to another embodiment, the trough 106 includes a cooling coil or tubing configured to actively transport heat received from extruded material coating the coated wire 111.

The system 100 further includes take up 112 configured to receive and store cooled cable 112. Cooled cable 112 may be a cooled form of coated cable 111, and may have cosmetic surface attributes of consistent and repeatable quality. The Takeup 105 may be coupled to a motor or rotating mechanism configured to turn Takeup 105 to facilitate receiving of the cooled cable 112. The Takeup 105 may include a reel or set of reels configured to wind and store the cooled cable 112.

The system 100 may further include ultrasonic generator 107 coupled to one or both of the die and tip of set 103. The ultrasonic generator 107 may be configured to generate mechanical vibrations of an ultrasonic frequency at one or both of the die and tip of set 103. The ultrasonic generator 107 may include a transducer, piezoelectric transducer, crystal, piezoelectric crystal or other suitable component configured to generate the ultrasonic frequency or a range thereof. The ultrasonic generator 107 may include an alternating voltage source coupled to the ultrasonic component to stimulate ultrasonic oscillations. According to one embodiment, the ultrasonic generator 107 is configured to generate an ultrasonic frequency of about 15 to 25 kilohertz (kHz). According to one embodiment, the ultrasonic generator 107 is configured to generate a range of ultrasonic frequencies between 15 to 25 kHz. According to one embodiment, the ultrasonic generator 107 is configured to generate an ultrasonic frequency of about 8 kHz. The frequency or range of frequencies generated at the ultrasonic generator 107 may be about or substantially equal to mechanical vibrations induced at the die or tip of set 103 through mechanical, electrical, or acoustic coupling. The mechanical, electrical, or acoustic coupling may include mechanical or electrical members coupled between the die and/or tip of set 103 and the ultrasonic generator 107.

Although described above as coupled to the die and tip set 103, the ultrasonic generator 107 may also be coupled to the crosshead 107 such that vibration of the crosshead 102 causes the disclosed vibration of the die and tip set 103.

The system may further include controller 108 configured to communicate to different components of the system 100 described above via one or more channels 109. Channels 109 may include standardized communication channels, discrete Input/Output (I/O) connections, isolated interlocks, and/or any other suitable communication mechanisms. The controller 108 may be any suitable controller, including a computer processor configured to execute a method of cable or wire extrusion as described herein. The controller 108 may be embodied as a general purpose processor or a specialized processor such as a programmable logic controller (PLC), programmable automation controller, computer numerical control (CNC) processor, or other specialized controller.

Although described above and illustrated as discrete components, it should be understood that one or more components of the system 100 may be integrated into a standalone extrusion apparatus for a product manufacturing facility. Furthermore, existing standalone extrusion apparatuses may be easily modified taking into consideration the teachings described herein to achieve significantly similar or substantially equivalent operation.

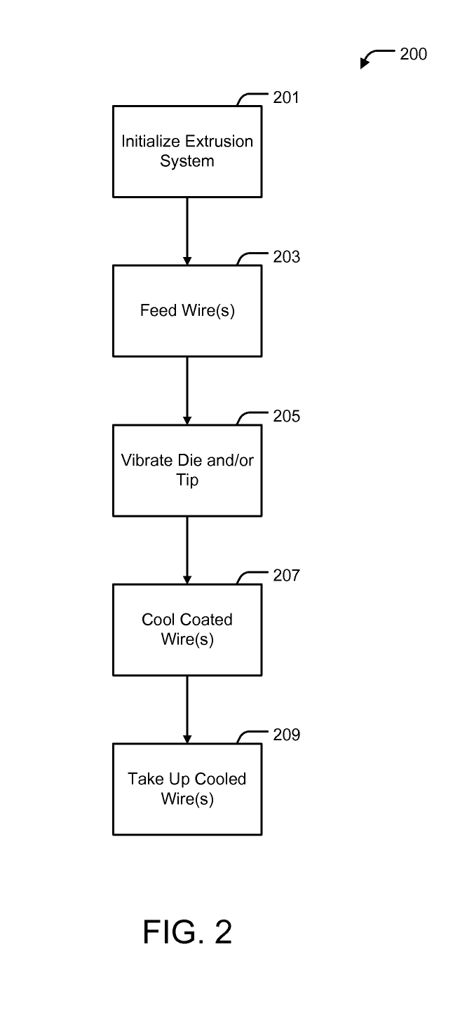

Hereinafter, a more detailed description of methods of extruding cabling and the physical characteristics of cabling resulting therefrom is provided with reference to FIG. 2.

FIG. 2 is a flowchart of a wire extrusion method 200, according to an embodiment of the invention. The method 200 includes initializing an extrusion system at block 201. Initializing the extrusion system may include initializing a material extruder 101 to begin to heat, soften, or melt material for extruding. Initializing the extrusion system may include initializing one or more components of a wire extrusion system 100, for example, by preparing a controller 108 to execute extruding algorithms or control sequences, by preheating a material extruder 101 and beginning a flow of material therethrough, and/or other suitable or desirable initializing steps.

The method 200 further includes feeding wire or wires into a crosshead of the initialized extrusion system at block 203. Feeding the wire or wires may include passing wire to be coated through a receiving cavity of a crosshead 102 and into a central cavity of a tip of set 103 (see FIG. 1).

The method 200 further includes vibrating one or both of a die and tip of the extrusion system while coating the received wire at block 205. The vibrating may occur continuously or may be intermittent. The vibrating may be at an ultrasonic frequency. According to one embodiment, the vibrating is at an ultrasonic frequency of about 15 to 25 kilohertz (kHz). According to one embodiment, the vibrating is at a range of ultrasonic frequencies between 15 to 25 kHz. According to one embodiment, the vibrating is at an ultrasonic frequency of about 8 kHz. According to one embodiment, only the die is vibrated relative to the tip. According to one embodiment, both the die and tip are vibrated.

The method 200 further includes cooling the coated wire at block 207. For example, cooling may be facilitated by a cooling trough 103, heat sink, or other cooling mechanism.

The method 200 further includes taking up cooled, coated wire at block 209. For example, a take up 105 may wind the cooled, coated wire onto one or more reels.

As described above, methods of extruding wire may include one or more steps including initializing an extrusion system, feeding wire into the extrusion system, vibrating a die and/or tip of the extrusion system while coating the wire to create coated wire, cooling the coated wire, and taking up the cooled coated wire. The vibrating may be at an ultrasonic frequency provided by an ultrasonic generator. Hereinafter, benefits of die/tip vibration are explained with reference to FIGS. 3-5.

FIG. 3 illustrates flow characteristics of material flowing through a stationary die and tip set 103A of a wire extrusion system. As illustrated, the die 301 is a generally cylindrical die having an inner conical wall 310. The tip 302 is a generally conical tip having a central cavity 303 for passing one or more wires for coating, and an outer conical wall 311. When engaged together, the inner conical wall 310 and the outer conical wall 311 form an extrusion cavity 304. The extrusion cavity 304 may be generally frustoconical in shape having a distal cylindrical cavity for expelling extruded material onto wire. The extrusion cavity 304 may receive softened or molten material from a manifold of a crosshead and force the same about wire passing through central cavity 303. Material flowing through the extrusion cavity 304 experiences pressure flow with shear forces of greatest magnitude nearest proximal walls 310, 311. Expanded view 312 illustrates velocity components and shear force components of material flowing through a portion of the extrusion cavity 304.

The profile of shear forces and velocity shown in view 312 may cause several undesirable physical attributes of cooled jacket material, for example, increased surface roughness, instances of glossy surface areas, and may increase the possibility of flow front disparity causing seams, knit lines, or weld lines upon convergence. Therefore, exemplary embodiments of the present invention provide novel vibration techniques to disrupt the shear force and velocity components in a manner which more repeatedly reduces these undesirable attributes. The same is described below with reference to FIG. 4.

FIG. 4 illustrates flow characteristics of material flowing through a vibrating die and/or tip set 103B of a wire extrusion system. As illustrated, the die 401 is a generally cylindrical die having an inner conical wall 410. The tip 402 is a generally conical tip having a central cavity 403 for passing one or more wires for coating, and an outer conical wall 411. When engaged together, the inner conical wall 410 and the outer conical wall 311 form an extrusion cavity 404. The extrusion cavity 404 may be generally frustoconical in shape having a distal cylindrical cavity for expelling extruded material onto wire. The extrusion cavity 404 may receive softened or molten material from a manifold of a crosshead and force the same about wire passing through central cavity 403. Material flowing through the extrusion cavity 304 experiences pressure flow with shear forces of disrupted magnitude near proximal walls 310, 311 due to mechanical vibration of one or both of the die 401 and tip 402 at an ultrasonic frequency. Expanded view 412 illustrates velocity components and shear force components of material flowing through a portion of the extrusion cavity 404.

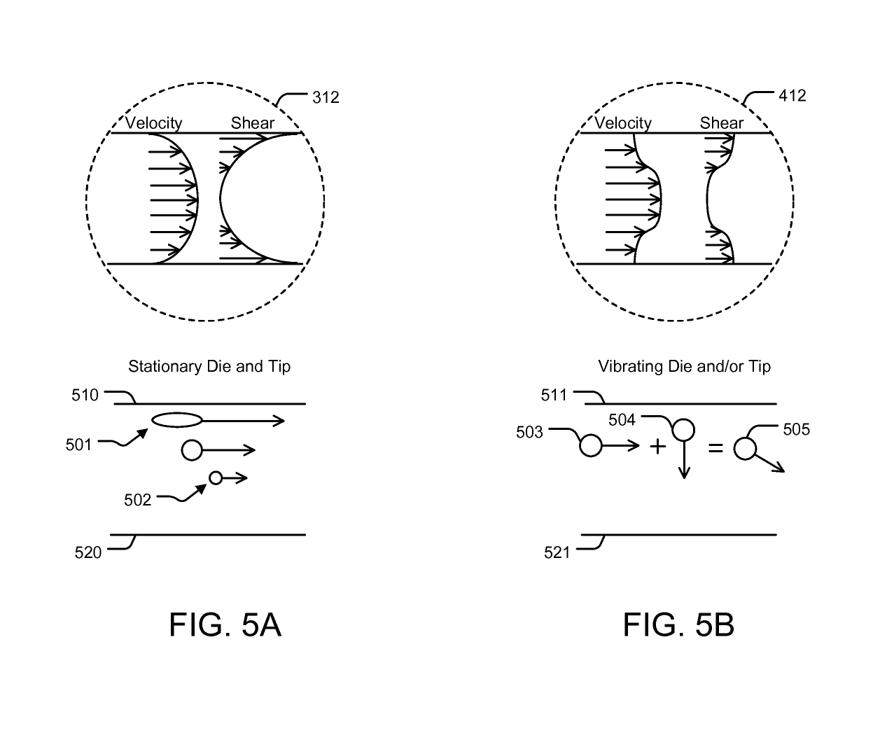

The profile of shear forces and velocity shown in view 412 may reduce or mitigate undesirable physical attributes of cooled jacket material, for example, by decreasing surface roughness and instances of glossy surface areas, and may limit disparity in flow fronts. The differences between the shear force components and velocity components are more clearly illustrated in FIGS. 5A-5B.

FIGS. 5A-5B illustrate shear stress and velocity changes due to a vibrating die and/or tip of a wire extrusion system. As shown, molecules 501 nearest die wall 510 (or tip wall 520) experience greater shear forces than molecules 502 within a central portion of an extrusion cavity of a stationary die and tip set 103A. In contrast, molecules 503 and 504 near die wall 511 and tip wall 521 experience less shear forces due to a changes in velocity (summation depicted at 505) caused by vibration of die wall 511 and/or tip wall 521.

It is noted that if only die wall 511 is vibrated, shear forces near tip wall 521 may still be increased, but cosmetic disparity in cooled coated wire may not be apparent due to tip wall 521 being in contact with an inner portion of extruded jacket material. However, physical characteristics including bend radius and flexibility may be altered with vibration of the tip wall 521 such that smoother interior surfaces of the extruded jacket material contact the coated wire. In this manner, the teachings of embodiments may facilitate more than just cosmetic advantages in extruded cables, and may promote advantages in jacket motion, stress relief, and other such benefits.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line or extrusion system somewhat similar to those described herein. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An extrusion system, comprising:
a die and tip defining an extrusion cavity, the extrusion cavity configured to receive material for extrusion and coating one or more wires, wherein the die is configured to vibrate at an ultrasonic frequency during coating the one or more wires.

2. The system of claim 1, further comprising:
an ultrasonic generator configured to vibrate the die during coating the one or more wires.

3. The system of claim 1, wherein the tip is also configured to vibrate at the ultrasonic frequency during coating the one or more wires.

4. The system of claim 1, further comprising:
a crosshead, the crosshead having an inlet configured to receive material for extruding and a manifold configured to transfer received material for extruding to the extrusion cavity.

5. The system of claim 4, further comprising:
a material extruder, the material extruder configured to heat material for extruding and transfer the heated material to the crosshead manifold.

6. The system of claim 5, further comprising:
a trough, the trough configured to receive and cool coated wire.

7. The system of claim 6, further comprising:
a take up, the take up configured to receive and store cooled coated wire.

8. The system of claim 7, wherein:
the tip comprises a central cavity configured to receive one or more wires to be coated.

9. The system of claim 8, further comprising:
a wire Payoff, the wire Payoff configured to supply wire to the central cavity of the tip.

10. The system of claim 6, wherein the crosshead, material extruder, and trough are integrally arranged as a standalone extrusion apparatus.

11. An extrusion system, comprising:
a crosshead configured to receive and distribute material for extrusion; and
a die and tip defining an extrusion cavity in mechanical communication with the crosshead, the extrusion cavity configured to receive the material for extrusion and coating one or more wires;
wherein the crosshead is configured to vibrate at an ultrasonic frequency and transfer vibrations to the die and tip during coating the one or more wires.

12. The system of claim 11, further comprising:
an ultrasonic generator configured to vibrate the crosshead during coating the one or more wires.

13. The system of claim 11, further comprising:
a material extruder, the material extruder configured to heat material for extruding and transfer the heated material to the crosshead.

14. The system of claim 13, further comprising:
a trough, the trough configured to receive and cool coated wire.

15. The system of claim 14, further comprising:
a take up, the take up configured to receive and store cooled coated wire.

16. The system of claim 15, wherein:
the tip comprises a central cavity configured to receive one or more wires to be coated.

17. The system of claim 16, further comprising:
a wire Payoff, the wire Payoff configured to supply wire to the central cavity of the tip.

18. The system of claim 14, wherein the crosshead, material extruder, and trough are integrally arranged as a standalone extrusion apparatus.

19. A method of wire extrusion, comprising:
heating extrusion material;
providing at least one wire to be coated by extrusion material;
feeding heated extrusion material and the at least one wire to a crosshead, the crosshead comprising at least a die and a tip;
vibrating the die of the crosshead at an ultrasonic frequency while extruding heated material while feeding wire into the crosshead thereby coating the wire with extruded material; and
cooling the coated wire.

20. The method of claim 19, further comprising:
vibrating the tip of the crosshead at the ultrasonic frequency while extruding material and coating the wire.

21. The method of claim 20, wherein the cooling further comprises passing the coated wire through a cooling trough.

22. The method of claim 21 further comprising winding the cooled coated wire on a take up reel.
